(19) United States
(12) Patent Application Publication
(10) Pub. No.: US 2024/0386203 A1
(43) Pub. Date: Nov. 21, 2024

(54) MACHINE-LEARNING PIPELINE FOR ONTOLOGY GENERATION VIA LARGE LANGUAGE MODELS

(71) Applicant: SupportLogic, Inc., San Jose, CA (US)

(72) Inventors: Alexandra Mably, San Jose, CA (US); Charles Monnett, San Jose, CA (US)

(21) Appl. No.: 18/662,625

(22) Filed: May 13, 2024

Related U.S. Application Data
(60) Provisional application No. 63/466,768, filed on May 16, 2023.

(51) Int. Cl. G06F 40/284

(52) U.S. Cl. CPC G06F 40/284

(57) ABSTRACT

A machine-learning pipeline for ontology generation via large language models is described. A system receives historical communications between support agents and customers, and multiple types of machine-learning models extract historical keywords from the historical communications. The system selects historical keywords which were identified by at least a specific number of the multiple types of machine-learning models. The system identifies some of the selected keywords from communications between support agents and customers, in response to receiving the communications. The system applies the identified keywords to recognizing skills required by a support agent to handle an open case, a trend in cases related to a product and/or a skill, and/or identifying skills for which support agents require additional training.

### CROSS REFERENCE TO RELATED APPLICATION

This application claims priority under 35 U.S.C. § 119 or the Paris Convention from U.S. Provisional Patent Application 63/466,768, entitled “MACHINE-LEARNING PIPELINE FOR ONTOLOGY GENERATION VIA LARGE LANGUAGE MODELS,” filed May 16, 2023, the entire contents of which is incorporated herein by reference as if set forth in full herein.

### BACKGROUND

A ticketing system (such as provided by Jira, GitHub, ServiceNow, Salesforce, Zendesk, or Freshdesk) generates tickets, which may be referred to as support tickets, service tickets, or cases, that track the communications between individuals, users, groups, teams, organizations, and businesses in spaces such as support, user service, sales, engineering and information technology. Although many of the following examples are described in the context of a ticketing system for a support space, embodiments of this disclosure apply equally to other ticketing systems for other spaces. In a support space example, a customer of a software product experiences a problem using the software product, activates a ticketing system, and submits a support ticket to the support organization which provides support for the software product.

The support organization employs support agents who can receive the support ticket and respond to the customer, which maintains strong accountability standards and commands customer loyalty. Robust technical support for software products underlies a strong, sustained, and successful partnership between support organizations and their customers. In an ideal situation, a support agent accurately identifies, troubleshoots, and resolves a customer's problem in a timely manner, and closes the support ticket.

Support organizations that have many customers typically have difficulty prioritizing their relationships with their customers or invest heavily into closely evaluating those relationships. Since software products are often intricately tied with customer workflows and operations, stabilizing this degree of customer dependence on a long-term basis requires a support organization to evolve and adapt to the customers' emerging and growing problems. If handled incorrectly, customer needs, such as those expressed in support tickets, can remain unresolved for long periods of time and result in dissatisfied customers, with outcomes ranging from poor customer satisfaction scores to disengagement and churn.

### BRIEF DESCRIPTION OF THE DRAWINGS

FIG. 1 illustrates a block diagram of example data structures for a machine-learning pipeline for ontology generation via large language models, under an embodiment;

FIG. 2 illustrates a block diagram of additional example data structures for a machine-learning pipeline for ontology generation via large language models, under an embodiment;

FIG. 3 illustrates a block diagram of an example system for a machine-learning pipeline for ontology generation via large language models, under an embodiment;

FIG. 4 illustrates a block diagram of an example voting system for a machine-learning pipeline for ontology generation via large language models, under an embodiment;

FIG. 5 is a flowchart that illustrates a computer-implemented method for a machine-learning pipeline for ontology generation via large language models, under an embodiment; and

FIG. 6 is a block diagram illustrating an example hardware device in which the subject matter may be implemented.

### DETAILED DESCRIPTION

This disclosure describes a system that can utilize keyword extraction techniques to generate a customer specific ontology. The ontology is derived entirely from individual customer data, and serves to support several software products, including but not limited to automated case assignment, and the keywords and trends page. An ontology consists of relevant and important keywords and phrases from customer data.

The term “keywords” is used herein as an umbrella term to refer to all the many different types of information that may be included in an ontology. The term “keywords,” is used to convey the idea that the ontology is a collection of important and relevant words and phrases that can help to categorize and make sense of customer data. This includes not only individual words, but also larger concepts, such as entities, technologies, products, and services that are relevant to the customer domain.

Keyword extraction is understood to be a complex problem within the field of Natural Language Processing (NLP). Common and current state of the art approaches for solving this problem include a variety of techniques, including statistical methods and machine-learning algorithms or models. Some of the most commonly used methods and algorithms for keyword and phrase extraction include the term frequency-inverse document frequency, TextRank, the Rapid Automatic Keyword Detection, Latent Dirichlet Allocation, and Large Language Models.

The term frequency-inverse document frequency (TF-IDF) is a statistical method that calculates the importance of each term in a document based on how frequently the term appears in the document and how rare the term is in the corpus as a whole. The TF-IDF method may be less effective for multi-word phrases or domain-specific terms.

The TextRank algorithm is an unsupervised machine-learning model that exploits the structure of a text itself and the text's intrinsic properties to determine key words and phrases that appear “central” or important to the text, instead of relying on any previous training data. The TextRank algorithm is computationally expensive and typically requires pre-processing steps.

The Rapid Automatic Keyword Detection (RAKE) method is a domain-independent unsupervised method that relies on statistical measures to identify candidate keywords and then ranks the keywords based on their frequency and co-occurrence with other terms in the document. The Rapid Automatic Keyword Detection method may be particularly useful for multi-word phrases and domain-specific terms, but this method does not perform as well when considering text with complex syntax or low frequency terms.

The Latent Dirichlet Allocation (LDA) method is a probabilistic topic modeling algorithm that identifies the underlying topics in a corpus and the words most closely associated with each topic. The Latent Dirichlet Allocation method is useful for extracting topics and themes, as well as keywords, but this method may be slow to execute and more computationally expensive.

Large Language Model (LLM) methods generally utilize transformer-based models, such as Bidirectional Encoder Representations from Transformers (BERT) or Generative Pre-trained Transformer (GPT). These transformer-based models may be fine-tuned for various Natural Language Processing tasks, including keyword and phrase extraction, and are tasks that are computationally expensive and have typically required a deeper understanding of machine-learning techniques.

While these methods have proven to be effective in certain use cases, they still have notable limitations. For example, some methods may be computationally expensive or require large amounts of labeled data for training. Other methods may be less effective for certain types of data, or for domain-specific content.

Overall, each method has inherent strengths and weaknesses. Therefore, to effectively and reproducibly extract key words and phrases from customer data, this disclosure describes a machine-learning pipeline that can take advantage of model strengths and overcome weaknesses, without requiring extensive manual labeling or data preprocessing. This disclosure addresses these limitations and improves upon the existing state of the art.

Given the limitations described above with current approaches, this disclosure describes overcoming the weaknesses of individual models by constructing a machine-learning pipeline to use multiple inter-changeable keyword extraction models. A machine-learning pipeline may be conceptualized as a set of steps used to process and transform data in order to achieve a specific goal. In this case, the goal is extracting relevant and important keywords and phrases from customer data, which include but are not limited to relevant skills, entities, concepts, technologies, products, and services. By utilizing models that each have separate underlying mechanisms, such as statistical, rule-based, and Large Language Models, the machine-learning pipeline can extract both a broad and specific set of keywords and phrases from the dataset.

The nature of customer data is such that any one machine-learning model may not be able to extract very broad terms, industry jargon, customer specific products, and customer services. No one machine-learning model alone can achieve this, however a concert of machine-learning models are able to return a rich set of keywords and phrases. To determine which of the plethora of keywords and phrases extracted are to be considered for the final output following the machine-learning model extraction steps, the machine-learning pipeline includes a voting system. The voting system requires a multiple-model consensus for an extracted keyword to be considered for the final output. The final step of the machine-learning pipeline is a count cutoff, such that keywords that were not extracted at a high enough frequency are excluded from the final output.

Embodiments describe a machine-learning pipeline for ontology generation via large language models. A system receives historical communications between support agents and customers, and each of multiple types of machine-learning models extract historical keywords from the historical communications. The system selects historical keywords which were extracted by at least a specific number of the multiple types of machine-learning models. The system receives communications between support agents and customers, and identifies keywords from the communications. The system applies the identified keywords to recognizing skills required by a support agent to handle an open case, a trend in cases related to a product and/or a skill, and/or identifying skills for which support agents require additional training.

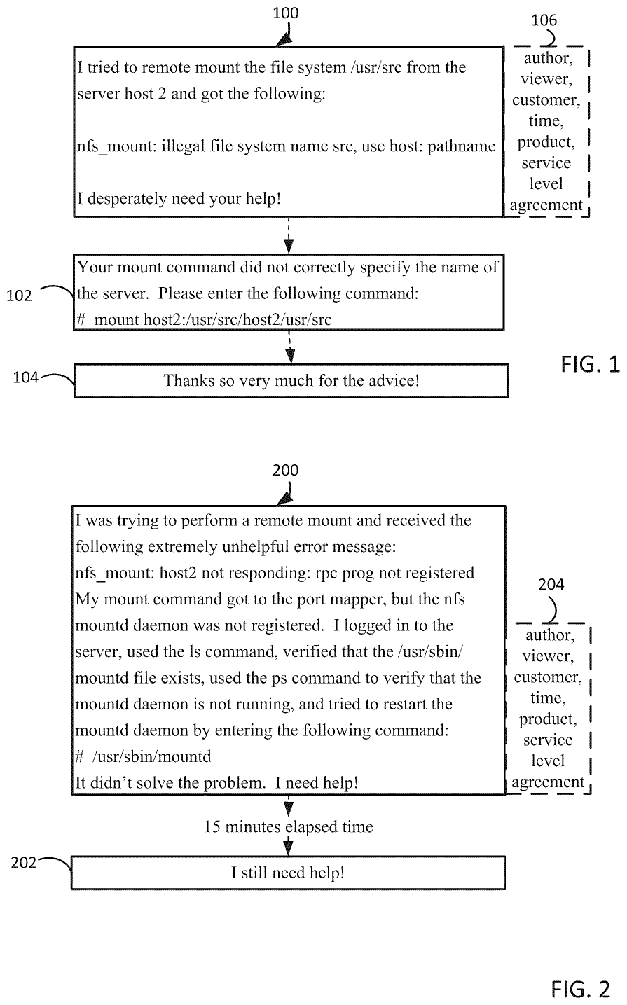

For example, a system has a server that receives a set of closed customer support cases, which includes the support ticket 100 that contains subsequent communications 102 and 104 and the support ticket's metadata 106, as depicted by FIG. 1. Then the server's four different types of machine-learning models determine that a customer submitted the support ticket 100, which contained a request for help with a remote mount procedure, extract many keywords including “remote mount,” and subsequently vote to add the “remote mount” keywords to a static keyword list for the customer support provider.

The system's server receives support tickets, which include the support ticket 200 that contains the subsequent communication 202 and the support ticket's metadata 204, as depicted by FIG. 2. The system identifies that the support ticket 200 includes a request for help with a remote mount problem, which matches the keywords “remote mount” from the static list of keywords. The system conveys these “remote mount” keywords to downstream applications and/or models, one of which assigns the customer's remote mount problem to support agents who have the related skills to assist with remote mount problems and are eligible to be assigned the support ticket 200.

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Although these embodiments are described in sufficient detail to enable one skilled in the art to practice the disclosed embodiments, it is understood that these examples are not limiting, such that other embodiments may be used, and changes may be made without departing from their spirit and scope. For example, the operations of methods shown and described herein are not necessarily performed in the order indicated and may be performed in parallel. It should also be understood that the methods may include more or fewer operations than are indicated. In some embodiments, operations described herein as separate operations may be combined. Conversely, what may be described herein as a single operation may be implemented in multiple operations.

Reference in the specification to “one embodiment” or “an embodiment” or “some embodiments,” means that a particular feature, structure, or characteristic described in conjunction with the embodiment may be included in at least one embodiment of the disclosure. The appearances of the phrase “an embodiment” or “the embodiment” in various places in the specification do not necessarily all refer to the same embodiment.

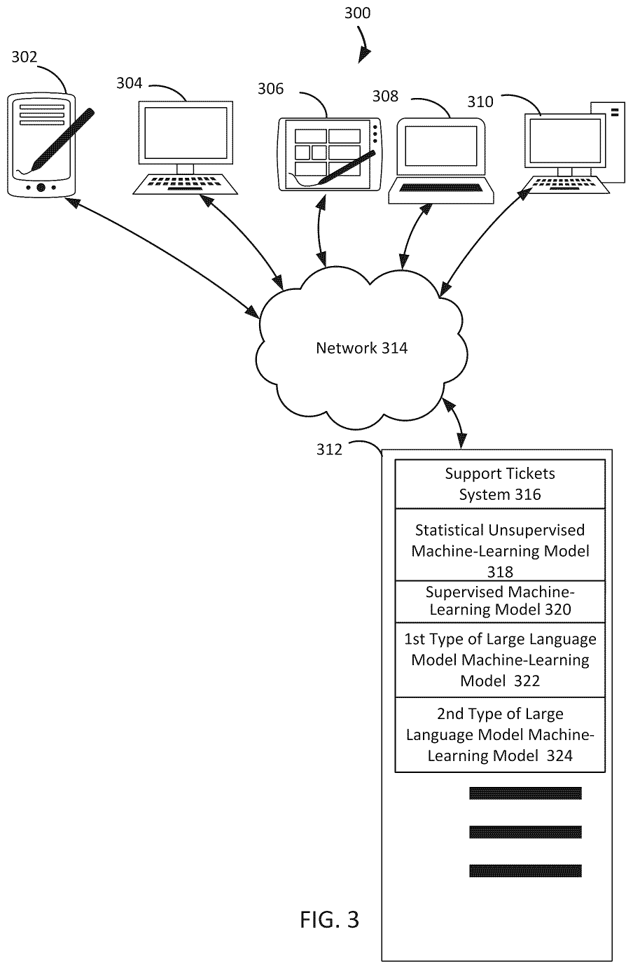

FIG. 3 illustrates a block diagram of an example system 300 for a machine-learning pipeline for ontology generation via large language models, under an embodiment. As shown in FIG. 3, the system 300 may illustrate a cloud computing environment in which data, applications, services, and other resources are stored and delivered through shared data centers and appear as a single point of access for customers. The system 300 may also represent any other type of distributed computer network environment in which servers control the storage and distribution of resources and services for different client users.

In an embodiment, the system 300 represents a cloud computing system that includes a first client 302, a second client 304, a third client 306, a fourth client 308, a fifth client 310; and a server 312 that may be provided by a hosting company. The clients 302-310 and the server 312 communicate via network 314.

The server 312 may include a support tickets system 316, which may include an unsupervised machine-learning model 318, a supervised machine-learning model 320, a first type of a Large Language Model machine-learning model 322, and a second type of a Large Language Model machine-learning model 324. The server 312 can train the supervised machine-learning model 320, but does not need to for the machine-learning pipeline to function.

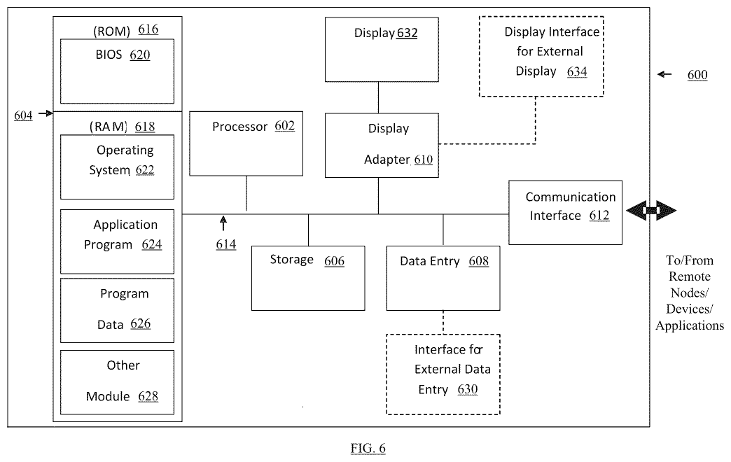

Even though FIG. 3 depicts the first client 302 as a smartphone 302, the second client 304 as a terminal 304, the third client 306 as a tablet computer 306, the fourth client 308 as a laptop computer 308, and the fifth client 310 as a personal computer 310, each of the system components 302-312 may be any type of computer system. The system elements 302-312 may each be substantially similar to the hardware device 600 depicted in FIG. 6 and described below. FIG. 3 depicts the system 300 with five clients 302-310, one server 312, one network 314, one support tickets system 316, and four machine-learning models 318-324. However, the system 300 may include any number of clients 302-310, any number of servers 312-, any number of networks 314, any number of support tickets systems 316, and any number of machine-learning models 318-324.

The natural language processor machine-learning models 318-324 may provide an efficient user experience by enabling humans to communicate in the modes in which they are naturally most comfortable—that of conventional language. A consequence of the breadth and ease with which humans communicate with one another in natural language is that inferring meaning from a support ticket's content may be challenging. Therefore, the natural language processor machine-learning models 318-324 rely on a multitude of advanced natural language processing techniques, some of which fall under the domain of machine-learning model techniques. The primary input when determining keywords of a support ticket may be the content of the support ticket. Although the natural language processor machine-learning models 318-324 are oriented to mining information from text content, a well-performing voice-to-text application could render the natural language processor machine-learning models 318-324 as useful for voice calls as well.

The natural language processor machine-learning models 318-324 can infer tags, labels, or classifiers that may be used to summarize and/or describe the content of input language. This natural language processor machine-learning models 318-324 may be described as an attentional machine-learning model to learn not just the weights of the input words and phrases in how they pertain to a classifier, but also which words and phrases are most relevant to predictions of a classifier given the structure of the input words and phrases. The qualifier “attentional” derives from the notion that this technique is, broadly speaking, similar to the manner in which humans choose what to pay attention to when focusing on a task. A customer who is experiencing a catastrophic computer system failure may give far greater weight to the computer system than to the clouds in the sky outside or the carpet in the room. Similarly, an attentional model can give far greater weight to the input that it deems most relevant to the task at the expense of other inputs.

This attentional model technique may represent a stark contrast to bag of words models in which all weights for an input have equal importance, and which discards the structure of the input. A bag of words model may be a natural language processing technique used for classifying natural language text, such as assigning a classification of positive or negative to a movie review based on the positive and negative words in the review's natural language text. Bag of words models may be trained to learn tokens, which are particular words or small phrases, and learn weights for the tokens, which are associated with classes or classifiers.

Continuing with the movie review example, since the token bad is in more negative reviews than positive reviews, a bag of words model learns a negative weight for the token bad. Although bag of words models may be reasonably accurate when classifying long documents, these models produce noisy results for small input sizes, such as sentence- or phrase-level texts, because of the small number of tokens available for weighting. Even classifying long documents may be problematic when dealing with technical support communications which often includes both human-generated natural language text and machine-generated text which is not in a natural language.

Attentional predictions may be made using a combination of general language models used to infer the syntax (structure and/or organization) of input language and task-specific models used to provide weight to language within the inferred structure. There may be several key outcomes of inferring the syntax of language in order to make predictions, in particular determining the role, such as parts of speech, of individual words, as well as the relationship of words and phrases to one another. Using combinations of tagged parts of speech and word or phrasal relationships may enable advanced behaviors such as determining whether a word or phrase in particular is being negated, expressed in a conditional or hypothetical manner, or expressed in a specific tense or mood. These advanced behaviors may greatly increase the accuracy of text classification on short documents which cause great challenges for conventional methods.

The simplest way in which predictions may be influenced by syntactic features is the suppression of key phrases that are negated. Conceptually this negation is straightforward in the example, “This is not a high priority issue.” However, in practice the natural language processor machine-learning models 318-324 are reliant on general language models that can achieve high accuracy using a technique called dependency parsing, in which direct, binary relationships are established between words in a sentence.

For example, in the sentence “This is a small problem,” the word “small” is directly related to the word “problem,” the word “This” is directly related to the word “is,” the word “is” is directly related to the word “a,” and the word “a” is directly related to the word “small” and indirectly to the word “problem.” The dependency chain may be followed to conclude that the word “This” is also indirectly related to the word “problem.”

Applying the same technique to the more complex example, “This is not a small problem, it is a disaster,” determines that the word “it” is indirectly related to the word “disaster,” the word “not” is indirectly related to the word “problem,” and very importantly that the word “not” is not related to the word “disaster.” This attentional model technique may provide much more accurate information as to the content of this text than a technique that would simply detect the presence of negative tokens such as “not” and negate any and all predictions pertaining to that text. Returning to the support context, this same attentional model technique can excel where other models do not, such as in the following example “This is a high priority issue and your response is not helpful.”

Modifying predictions of classifiers for words or phrases that occur within a conditional or hypothetical context may be crucial for suppressing would-be problems or outcomes that people naturally and frequently express. For example, technical support customers frequently express concern about problems that may not have actually happened, such as, “If this system had gone down, we would have had a major catastrophe on our hands.” Since the customer narrowly avoided a major catastrophe, and if the keyword extraction was being used to assign the corresponding support ticket to a support agent, then the support ticket may be assigned to a support agent with experience in resolving support tickets in a far less urgent manner than a support ticket from a customer who was in the midst of an ongoing catastrophe.

In such situations, using language-aware techniques may enable the natural language processor machine-learning models 318-324 to suppress language of this type from being surfaced up to or even being sent directly to an inbox of a support organization's upper management. The language-aware techniques may result in increased accuracy of the natural language processor machine-learning models 318-324, and greater confidence by support organizations that the support tickets system 316 assigns a support agent with sufficient experience to a support ticket. In contrast, a bag of words approach that searches for conditional terms such as would, could, and should, can only identify a small portion of expressions of the subjunctive mood and would unnecessarily suppress predictions when a conditional term is unrelated to the key aspects of the language being evaluated, such as “We have a major catastrophe on our hands—we would appreciate a response immediately!”

The machine-learning pipeline that includes such machine-learning models 318-324 is designed to be customizable at every step. Data collection may be customized allowing for keywords to be extracted from only specific communications or over a specific time period. The machine-learning models 318-324 which are included in the machine-learning pipeline are customizable, such that a very rigorous or lenient machine-learning pipeline may be constructed, depending on the use case. Finally, the voting and count strategies may be customized to control how many terms are returned.

The system 300 ingests customer support data, on behalf of its clients, from various customer relationship management (CRM) systems. This data includes, but is not limited to email, chat and voice communication. Support data consists of a detailed conversational log between a customer and a support agent intended to address product, information technology (IT), and other technical issues that a customer is facing while using a product. Each conversation initiated by a customer may be referred to as a case. Within the system 300, each case can contain multiple different types of communications, such as initial comments, inbound comments, outbound comments, case notes, and metadata

An initial comment is the first communication received from a customer, which initiates or opens a case. Inbound comments are the subsequent communications sent from a customer and received by a support agent. Outbound comments are communications sent from a support agent and received by a customer. Case notes are internal notes on a case, recorded by a support agent, for use internally by support personnel, who include other support agents and support managers. Metadata are fields of information about a case, which the system 300 extracts from the case.

The data collection step for the machine-learning pipeline is designed so that any combination of comment types may be used for keyword extraction. Additionally, there are multiple settings available to control the time period of data collected. A date range may be provided, in which case only comments from within that date range are considered for processing. Alternatively, a comment limit setting results in the most recent comments being returned, up to the given limit of comments. If both settings are provided, their characteristics intersect, such that the given maximum number of comments from the given time period may be considered for processing and keyword extraction.

Data is minimally preprocessed. Pre-processing algorithms can detect and remove header and footer content of a comment, remove comments that are considered too short to provide useful information, and remove comments that are too long to be processed in a timely manner. The calculation to remove excessively short and long comments from a dataset may be represented as:

$${C}^{′} = [ d ϵ C \vert x < \vert d \vert < y ] , \qquad Equation ( 1 )$$

where C′ is the resulting corpus, and d represents individual documents (such as comments) in the corpus, and x and y represent the lower and upper bounds of comment length, respectively. The data is further prepared, according to individual model requirements, prior to keyword extraction via the machine-learning models 318-324.

The machine-learning pipeline executes two main operations to extract keywords from customer data. The initial operation extracts as many potential keywords as possible, as each of the multiple different machine-learning models 318-324 process each comment within the corpus. The second operation applies a voting system with the purpose of reducing the number of potential keywords to only the most relevant keywords.

The machine-learning models 318-324 that are included in the machine-learning pipeline may include a TextRank model, a BERT (yanekyuk/bert-uncased-keyword-extractor) model and a GPT-3.5-turbo model, which are Large Language Models, and a Flair (ner-english-ontonotes-large) model, which is a Natural Language Processor Named Entity Recognition Machine-Learning Model. The machine-learning pipeline is specifically designed to allow any keyword extraction model to be substituted in and out, or added as an additional model. The more machine-learning models 318-324 that are included in the machine-learning pipeline, the larger the pool of potential keywords extracted.

Following keyword extraction by the configured keyword extraction machine-learning models 318-324, the system 300 uses a voting system to reduce a large number of keywords extracted to only the most relevant keywords. Voting relies on a multiple model consensus, such that a specific number of machine-learning models are required to have extracted the keywords that are included in the final output of the machine-learning pipeline. The voting is applied comment-wise. Therefore, for each keyword in the corpus, there must be a multi-model consensus that the specific keyword exists in that comment for the comment's keyword to be included in the final output.

KW is the list of lists of keywords extracted by each machine-learning model, defined as:

$$KW = [ {k}_{1} , {k}_{2} , {k}_{3} , … {k}_{n} ] , \qquad Equation ( 2 )$$

where kᵢ represents the keywords extracted by the ith machine-learning model,

$${k}_{i} = \{ {w}_{1} , {w}_{2} , {w}_{3} , … {w}_{m} \} . \qquad Equation ( 3 )$$

A function may be defined as:

$$f ( w ) = \vert [ i \vert w ϵ {k}_{j} ] \vert \qquad Equation ( 4 )$$

The output list of words from each comment may be calculated as:

$$\{ {w}_{w} \} = \{ w \vert f ( w ) \geq z \} , \qquad Equation ( 5 )$$

where z is the number of machine-learning models that are required to extract a keyword (w) for the keyword (w) to be included in the output list.

To prevent over-representation of words from an individual comment, the machine-learning pipeline returns keywords extracted by a machine-learning model from each comment as a set of keywords. Lastly, the machine-learning pipeline subjects the final keywords to a count cutoff, such that keywords that were not extracted from more than g number of comments are excluded. The variable g may be calculated as a proportion of the number of comments in the dataset. For example, if a dataset contains 1,000 comments, and the machine-learning pipeline is parameterized to require keywords to occur in at least 1% of the comments, g would equal 10, and only keywords that occurred in at least 10 comments would be included. The variable g can also be a static number, and not update dynamically with the number of comments.

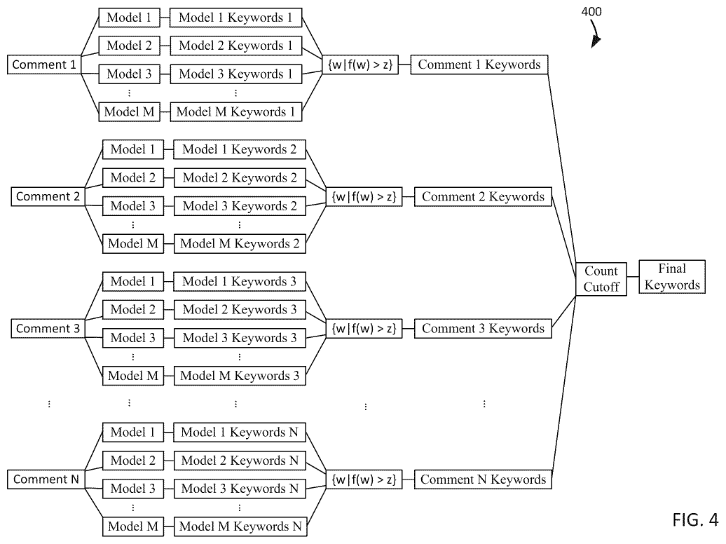

FIG. 4 illustrates a block diagram of an example voting system 400 for a machine-learning pipeline for ontology generation via large language models, under an embodiment. The voting system 400 represents a machine-learning pipeline that includes M machine-learning models that process N comments to extract M multiplied by N sets of keywords, which are reduced to N comments' sets of keywords and then reduced to the final keywords. The voting system 400 inputs a data set that consists of N comments, with the voting system 400 representing the first three comments 1, 2, and 3 and the last comment N of the N comments. When comment 1 is processed by the machine-learning pipeline, each of the M machine-learning models in the pipeline will process comment 1 and extract a set of zero or more keywords from comment 1. The voting system 400 represents the first three machine-learning models and the last machine-learning model in the pipeline as the models 1, 2, 3, and M, which extract their own individualized sets of keywords, which therefore total M sets for comment 1, which are represented as model 1 keywords 1. model 2 keywords 1, model 3 keywords 1, and model M keywords 1.

After each of the M models extracts its own individualized set of zero or more keywords from comment 1, each of the M models “votes” for each of the keywords which the model extracted from comment 1. The machine-learning pipeline counts the votes from each of the M machine-learning models for its keywords, and if a keyword 1 receives a sufficient number of votes, then the pipeline will retain keyword 1. However, if a keyword 1 fails to receive a sufficient number of votes from the M machine-learning models, then the machine-learning pipeline will discard keyword 1. For example, if machine-learning model 1 has extracted the keywords “logs” and “processor” from comment 1, machine-learning model 2 has extracted the keyword “print” from comment 1, machine-learning model 3 has extracted the keywords “processor” and “service” from comment 1, and machine-learning model 4 has extracted the keywords “logs” and “processor” from comment 1, and the voting parameter is 3, then the only keyword with the sufficient number of 3 models voting for the keyword is “processor.” If the voting parameter was 2, then both the keywords “logs and “processors” would have sufficient numbers of models voting for these keywords for the keywords to be retained for comment 1. The required number of votes may be set to reflect the majority of the machine-learning models in the machine-learning pipeline, such as three votes required for five models, but the specific number can be set to any value, such as two votes required for four models, three votes required for four models, or two votes required for five models.

In addition to extracting keywords from comment 1 and counting the machine-learning models' votes for comment 1 to determine which of the keywords extracted from column 1 are retained for further processing, the machine-learning pipeline repeats the same process for comment 2 and comment 3, all the way through comment N. Applying the same process to each of the N comments results in each comment's individualized set of keywords, which retains keywords extracted from the comment if enough models voted for the keyword. The voting system 400 depicts the first three comments' sets of key words and the last comment's set of keywords for N comments' sets of keywords.

Then the machine-learning pipeline combines all of the keywords from all of the comments' sets of keywords after model voting has refined the keywords, and compares the count of the number of comments which include any specific keyword in its set to a count cutoff, which determines whether a sufficient number of comments included the specific keyword in its set for the specific keyword to be included in the final keywords which are output for an applied use of keywords. For example, if the machine-learning pipeline requires each specific keyword to be extracted from at least 1% of the N comments, and N equals 1,000, then only each specific keyword which was extracted from 10 or more comments will be output for applied use.

As described above, one of the machine-learning models available to the machine-learning pipeline is GPT-3.5-turbo, also known as “ChatGPT”. This is a state-of-the-art Large Language Model released by OpenAI in November 2022. To obtain accurate and useful responses from chatGPT it is necessary to engineer the correct prompts, which are then delivered via an Application Programming Interface (API).

Part of the development of the machine-learning pipeline also includes research into prompts that would elicit error-free and serviceable responses. One possible current prompt utilizes a number of different tactics to prime a Large Language Model to return the desired results. This prompt can include priming the Large Language Model to behave as if it has been trained to extract keywords from customer support text data, providing examples of the format of input data and the expected format of the output data. Although not identical to the typical training of machine-learning models, this priming of the Large Language Model to behave as if it has been trained to extract keywords from customer support text data may be described as a different type of training of a machine-learning model.

The prompt can also include defining a list of do's and don'ts with regards to the type of keywords that may be returned, the length of keywords (and/or phrases) that should be returned, the removal of erroneous punctuation, and the format of the output that should be returned. Much like many other aspects of this machine-learning pipeline, the chatGPT prompt is customizable and may be replaced with a more relevant prompt if required.

This machine-learning pipeline utilizes multiple Large Language Models 322-324 to extract a customer ontology from customer support ticket data. The resulting output is a list of keywords and phrases that are representative of a customer's technologies, products, and services. These terms are of great importance to customer support organizations, and can take a substantial amount of time to curate by hand.

Such a list of keywords have many uses when understanding customer support organizations, and aiding in their triaging, handling, and analysis of their cases. Some example use cases include recognizing the skills required for support agents to handle incoming cases, observing trends in customer support cases related to specific products or skills, and identifying skills for which support agents require additional training. Furthermore, due to a flexible and customizable nature, the machine-learning pipeline can easily be re-configured to ingest data from multiple customers, and identify keywords and phrases in whole verticals/sectors, rather than just for individual customers. The machine-learning pipeline is designed to utilize state-of-the-art Large Language Models 322-324 in concert with simpler keyword extraction models 318-320 to take advantage of each models' strengths, whilst compensating for individual model weaknesses. A comprehensive multi-model voting strategy enables the initial creation of a very broad and deep pool of potential keywords, and then a narrowing to just the most relevant and important terms. Unlike current methods of support ontology generation, which are subjective and time consuming to create, the machine-learning pipeline results in an ontology drawn for a customer's actual support data.

The entities that the support tickets system 316 analyzes may be relevant even beyond the support domain, because factors extracted from these entities and their evolving relationships may be used to model behavior patterns in other business workflows which operate on the assumption of the desire for continuously sustained business relationships between a customer of a product and an organization related to the product across multiple product cycles. Therefore, the use of the system 300 that determines support ticket keywords may be extended beyond the support space to prioritize resources for responses to the communications between individuals, users, groups, teams, organizations, and businesses in spaces such as user service, sales, engineering, information technology, pharmaceutical, healthcare and medical devices industry, as well as the consumer electronics industry, which may use ticketing systems such as Jira, GitHub, ServiceNow, Salesforce, Zendesk, and Freshdesk.

The support tickets system 316 may be deployed and leveraged in a variety of different ways. The support tickets system 316 can provide recommendations for support agents to accept assignment of a given support ticket in a decentralized approach, where each support agent views a list of support ticket s they are best suited for in their own user interface, or the support tickets system 316 can directly assign support tickets to support agents. The support tickets system 316 can provide an overview of all open support tickets. The support tickets system 316 may be deployed for tasks that use recommender systems, such as user-based filtering, and collaborative filtering.

There are a variety of key benefits associated with deploying the support tickets system 316. From a customer point of view, support ticket resolution times may be faster, escalations can reduce, sentiment scores can increase, needs attention scores may be lower, customer engagement may be higher, and some direct form of end-user rating may be higher, such as higher customer satisfaction scores. From a support organization's point of view, costs associated with escalations may be reduced, customer disengagement and churn may be reduced, costs associated with sudden collaborations/resource allocation required may be saved when support tickets stop making progress (via Pods, mentoring queue, expert queue), knowledge transfer may be facilitated (surfaces paths to support ticket resolution for similar support tickets; surfaces experts), a robust system to improve support agent skills over time may be provided, overall support efficacy may be improved, support agents may be retained for longer terms; and burnout may be prevented.

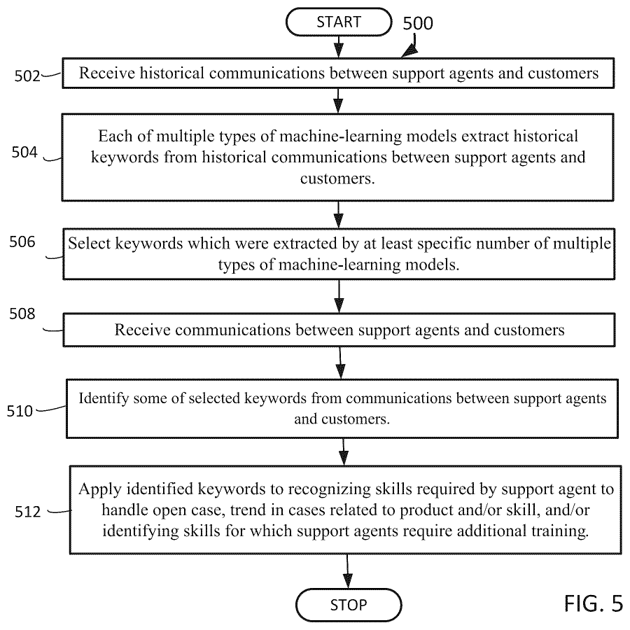

FIG. 5 is a flowchart that illustrates a computer-implemented method for a machine-learning pipeline for ontology generation via large language models, under an embodiment. Flowchart 500 depicts method acts illustrated as flowchart blocks for certain actions involved in and/or between the system elements 302-324 of FIG. 3.

Historical communications between support agents and customers are received, block 502. The system receives a set of closed support tickets for multiple types of machine-learning models to extract keywords from the tickets. For example, and without limitation, this can include the server 312 receiving a set of support communications, which includes the support ticket 100 that contains all subsequent communications 102 and 104 and the support ticket's metadata 106, as depicted by FIG. 1.

A historical communication can be a past conveying of information or news. A customer can be a person or organization that buys goods and/or services from a business. A support agent can be a person who is responsible for providing an act of assistance.

The historical communications which are received may be based on at least one of a time range or a maximum number of most recent historical communications. For example, the server 312 receives all of support tickets which were opened during the last two months and were closed. A time range can be a contiguous chronological interval. A maximum number can be an arithmetical value which is the highest possible or permitted in a situation. A most recent historical communication can be the conveyance of information or news which is the first to precede a specific time in the past.

Each historical communication may be a textual communication and/or an audio communication, and may be associated with a communication length that is as long as a minimum length and/or as short as a maximum length. For example, the support ticket 100 includes a customer's written comment that is 32 words in length, as depicted by FIG. 1.

A textual communication can be a written conveying of information or news. An audio communication can be a conveying by sound of information or news. A communication length can be the measurement or extent of the conveying of information or news, from beginning to end. A maximum length can be the measurement or extent of something from beginning to end, which is the highest possible or permitted in a situation. A minimum length can be the measurement or extent of something from beginning to end which is the smallest possible or permitted in a situation.

Each historical communication may be an initial comment, an inbound comment from a customer to a support agent, an outbound comment from a support agent to a customer, an internal note on a case made by a support agent for other support personnel, and/or metadata. For example, the support ticket 100 includes a customer's initial comment that opened the case, which was followed by a subsequent communication 102, which is an outbound comment, as FIG. 1 depicts. An initial comment can be a written or spoken remark by a customer expressing an opinion or reaction, which opens a case. An inbound comment can be a written or spoken remark by a customer expressing an opinion or reaction. An outbound comment can be a written or spoken remark to a customer which expresses an opinion or reaction by a support agent. An internal note can be a brief record of facts, topics, or thoughts. Support personnel can be people who are responsible for directly or indirectly providing acts of assistance. A metadata field can be an area of information about a case which is extracted from the case. A case can be a request logged on a work tracking system detailing a problem that needs to be addressed.

After receiving historical communications between customers and support agents, each of multiple types of machine-learning models extract historical keywords from the historical communications, block 504. The system's multiple types of machine-learning models extract historical keywords from tickets. By way of example and without limitation, this can include the machine-learning models 318-324 analyzing the support ticket 100, determining that a customer submitted the support ticket 100, which contained a request for help with a remote mount procedure, and extracting the keywords “remote mount.” A type can be a category of things having common characteristics. A machine-learning model can be an application of artificial intelligence that provides a system with the ability to automatically learn and improve from experience without being explicitly programmed. A historical keyword can be a representative grammatical unit used in an information retrieval system to indicate the content of a communication.

Each machine-learning model may extract any number of historical keywords in each communication as a set of keywords for the communication. For example, the unsupervised machine-learning model 318 extracted many historical keywords, such as “remote mount” from the initial comment in the support ticket 100, and extracted no historical keywords from the subsequent communication 104. Any number can be an arithmetical value that is equivalent to zero or more than zero. A set can be a group or collection of any number of things that belong together or resemble one another or are usually found together.

Extracting historical keywords from historical communications between support agents and customers may include determining for each individual historical keyword that a count of historical communications which include the individual historical keyword exceeds a threshold number of historical communications. For example, at least three of the four machine-learning models 318-324 must agree that the initial comment in the support ticket 100 includes the keywords “remote mount” extracted by the unsupervised machine-learning model 318 and two other models to be considered for inclusion for further processing and possibly in the final output of keywords by the machine-learning pipeline. A threshold number can be an arithmetical value which must be met in order for a certain reaction or condition to occur or be manifested.

The multiple types of machine-learning models may be based on a statistical unsupervised machine-learning model, a supervised machine-learning model, and/or at least one Large Language Model. For example, the server 312 executes a machine-learning pipeline that includes the four machine-learning models 318-324, which include an unsupervised machine-learning model 318, a supervised Machine-Learning Model 320, a first Large Language Model 322, and a second Large Language Model 324. An unsupervised machine-learning model can be an application of artificial intelligence that provides a system with the ability to extract key words and phrases from a text without relying on any previous training data. A supervised machine-learning model can be an application of artificial intelligence that provides a system with the ability to automatically learn and improve from experience without being explicitly programmed, and that extracts key words and phrases from a text relying on previous training data. A Large Language Model can be an artificial neural network that achieves general purpose communications with humans.

Following the extracting of historical keywords by multiple types of machine-learning models, the historical keywords are selected if they were extracted by at least a specific number of the multiple types of machine-learning models, block 506. The system enables multiple types of machine-learning models to vote on selecting historical keywords. In embodiments, this can include the machine-learning models 318-324 narrowing the number of potential historical keywords by “voting” on which historical keywords should be selected for an applied use, thereby reducing the number of possible keywords, such as “remote mount,” which will be stored in a static list. The machine-learning models 318-324 can update the static list of keywords at a regular cadence. A specific number can be a clearly identified or defined arithmetical value.

After multiple machine-learning models select keywords from historical communications, communications between customers and support agents are received, block 508. The system receives a set of communications, such as open support tickets. For example, and without limitation, this can include the server 312 receiving open support tickets, which includes the support ticket 200 that contains the subsequent communication 202 and the support ticket's metadata 204, as depicted by FIG. 2. A communication can be a past conveying of information or news.

Having received communications some of the selected keywords are identified from the communications between customers and support agents, block 510. The system identifies the keywords selected by the machine-learning model pipeline from current communications between customers and support agents. By way of example and without limitation, this can include the server 312 identifying the selected keywords “remote mount” in a customer's request for help with a remote mount problem.

Following the identification of keywords, the identified keywords are applied to recognizing skills required by a support agent to handle an open case, a trend in cases related to a product and/or a skill, and/or identifying skills for which support agents require additional training, block 512. The system applies the keywords selected by the machine-learning model pipeline to various use cases. In embodiments, this can include the server 312 conveying the identified keywords to downstream applications and/or models, one of which provides a number of possible reasons for a customer's remote mount problem to support agents who have the related skills to assist with the software product problem and are eligible to be assigned the support ticket 200. In another example, the server 312 conveys the identified keywords to downstream applications and/or models, one of which determines that a disproportionally large number of customers have initiated support tickets for assistance with remote mount problems, which implies that a specific software product may lack clear usage instructions, error messaging, and/or self-help guidance related to remote mount procedures. In yet another example, the server 312 conveys the identified keywords to downstream applications and/or models, one of which determines that a disproportionally large number of support agents who have responded to support tickets to assist with problems related to remote mounts, need additional training to enable them to better assist customers who are experiencing problems with remote mounts.

A skill can be an ability to do something well. An open case can be a pending request logged on a work tracking system detailing a problem that needs to be addressed. A trend can be a general direction in which something is developing or changing. A product can be an entity that is manufactured or generated for sale. Additional training can be the extra or supplementary action of teaching a person a particular skill.

Although FIG. 5 depicts the blocks 502-512 occurring in a specific order, the blocks 502-512 can occur in another order. In other implementations, each of the blocks 502-512 can also be executed in combination with other blocks and/or some blocks may be divided into a different set of blocks.

### System Overview

An exemplary hardware device in which the subject matter may be implemented shall be described. Those of ordinary skill in the art will appreciate that the elements illustrated in FIG. 6 can vary depending on the system implementation. With reference to FIG. 6, an exemplary system for implementing the subject matter disclosed herein includes a hardware device 600, including a processing unit 602, a memory 604, a storage 606, a data entry module 608, a display adapter 610, a communication interface 612, and a bus 614 that couples elements 604-612 to the processing unit 602.

The bus 614 can comprise any type of bus architecture. Examples include a memory bus, a peripheral bus, a local bus, etc. The processing unit 602 is an instruction execution machine, apparatus, or device and can comprise a microprocessor, a digital signal processor, a graphics processing unit, an application specific integrated circuit (ASIC), a field programmable gate array (FPGA), etc. The processing unit 602 may be configured to execute program instructions stored in the memory 604 and/or the storage 606 and/or received via the data entry module 608.

The memory 604 can include a read only memory (ROM) 616 and a random-access memory (RAM) 618. The memory 604 may be configured to store program instructions and data during operation of the hardware device 600. In various embodiments, the memory 604 can include any of a variety of memory technologies such as static random-access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example.

The memory 604 can also include nonvolatile memory technologies such as nonvolatile flash RAM (NVRAM) or ROM. In some embodiments, it is contemplated that the memory 604 can include a combination of technologies such as the foregoing, as well as other technologies not specifically mentioned. When the subject matter is implemented in a computer system, a basic input/output system (BIOS) 620, containing the basic routines that help to transfer information between elements within the computer system, such as during start-up, is stored in the ROM 616.

The storage 606 can include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 600.

It is noted that the methods described herein may be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like can also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high-definition DVD (HD-DVD™), a BLU-RAY disc; and the like.

A number of program modules may be stored on the storage 606, the ROM 616 or the RAM 618, including an operating system 622, one or more applications programs 624, program data 626, and other program modules 628. A user can enter commands and information into the hardware device 600 through data entry module 608. The data entry module 608 can include mechanisms such as a keyboard, a touch screen, a pointing device, etc. Other external input devices (not shown) are connected to the hardware device 600 via an external data entry interface 630.

By way of example and not limitation, external input devices can include a microphone, joystick, game pad, satellite dish, scanner, or the like. In some embodiments, external input devices can include video or audio input devices such as a video camera, a still camera, etc. The data entry module 608 may be configured to receive input from one or more users of the hardware device 600 and to deliver such input to the processing unit 602 and/or the memory 604 via the bus 614.

A display 632 is also connected to the bus 614 via the display adapter 610. The display 632 may be configured to display output of the hardware device 600 to one or more users. In some embodiments, a given device such as a touch screen, for example, can function as both the data entry module 608 and the display 632. External display devices can also be connected to the bus 614 via the external display interface 634. Other peripheral output devices, not shown, such as speakers and printers, may be connected to the hardware device 600.

The hardware device 600 can operate in a networked environment using logical connections to one or more remote nodes (not shown) via the communication interface 612. The remote node may be another computer, a server, a router, a peer device or other common network node, and typically includes many or all of the elements described above relative to the hardware device 600. The communication interface 612 can interface with a wireless network and/or a wired network.

Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, the communication interface 612 can include logic configured to support direct memory access (DMA) transfers between the memory 604 and other devices.

In a networked environment, program modules depicted relative to the hardware device 600, or portions thereof, may be stored in a remote storage device, such as, for example, on a server. It will be appreciated that other hardware and/or software to establish a communications link between the hardware device 600 and other devices may be used.

It should be understood that the arrangement of the hardware device 600 illustrated in FIG. 6 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 600.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 6.

Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the descriptions above, the subject matter is described with reference to acts and symbolic representations of operations that are performed by one or more devices, unless indicated otherwise. As such, it is understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is described in a context, it is not meant to be limiting as those of skill in the art will appreciate that various of the acts and operations described hereinafter can also be implemented in hardware.

To facilitate an understanding of the subject matter described above, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system for a machine-learning pipeline for ontology generation via large language models, the system comprising:
one or more processors; and
a non-transitory computer readable medium storing a plurality of instructions, which when executed, cause the one or more processors to:
extract, by each of the plurality of types of machine-learning models, historical keywords from historical communications between support agents and customers, in response to receiving the historical communications;
select keywords which were extracted by at least a specific number of the plurality of types of machine-learning models;
identify some of the selected keywords from communications between support agents and customers, in response to receiving the communications; and
apply the identified keywords to at least one of recognizing skills required by a support agent to handle an open case, a trend in cases related to at least one of a product or a skill, or identifying skills for which support agents require additional training.

2. The system of claim 1, wherein the historical communications are received based on at least one of a time range or a maximum number of most recent historical communications.

3. The system of claim 1, wherein extracting historical keywords from historical communications between support agents and customers comprises determining for each individual historical keyword that a count of historical communications which include the individual historical keyword exceeds a threshold number of historical communications.

4. The system of claim 1, wherein each machine-learning model identifies any number of historical keywords in each historical communication as a set of historical keywords for the historical communication.

5. The system of claim 1, wherein each historical communication comprises at least one of a textual communication or an audio communication, and is associated with a communication length that is at least one of as long as a minimum length or as short as a maximum length.

6. The system of claim 1, wherein each historical communication comprises at least one of an initial comment, an inbound comment from a customer to a support agent, an outbound comment from a support agent to a customer, an internal note on a case made by a support agent for other support personnel, or metadata.

7. The system of claim 1, wherein the plurality of types of machine-learning models are based on at least one of a statistical model, an unsupervised machine-learning model, a supervised machine-learning model, or at least one large language model.

8. A computer-implemented method for a machine-learning pipeline for ontology generation via large language models, the computer-implemented method comprising:
identifying, by each of the plurality of types of machine-learning models, historical keywords from historical communications between support agents and customers, in response to receiving the historical communications;
selecting historical keywords which were identified by at least a specific number of the plurality of types of machine-learning models; and
identifying some of the selected keywords from communications between support agents and customers, in response to receiving the communications; and
applying the identified keywords to at least one of recognizing skills required by a support agent to handle an open case, a trend in cases related to at least one of a product or a skill, or identifying skills for which support agents require additional training.

9. The computer-implemented method of claim 8, wherein the historical communications are received based on at least one of a time range or a maximum number of most recent historical communications.

10. The computer-implemented method of claim 8, wherein identifying historical keywords from historical communications between support agents and customers comprises determining for each individual historical keyword that a count of historical communications which include the individual historical keyword exceeds a threshold number of historical communications.

11. The computer-implemented method of claim 8, wherein each machine-learning model identifies any number of historical keywords in each historical communication as a set of historical keywords for the historical communication.

12. The computer-implemented method of claim 8, wherein each historical communication comprises at least one of a textual communication or an audio communication, and is associated with a communication length that is at least one of as long as a minimum length or as short as a maximum length.

13. The computer-implemented method of claim 8, wherein each historical communication comprises at least one of an initial comment, an inbound comment from a customer to a support agent, an outbound comment from a support agent to a customer, an internal note on a case, made by a support agent for other support personnel, or metadata.

14. The computer-implemented method of claim 8, wherein the plurality of types of machine-learning models are based on at least one of a statistical model, an unsupervised machine-learning model, a supervised machine-learning model, or at least one large language model.

15. A computer program product, comprising a non-transitory computer-readable medium having a computer-readable program code embodied therein to be executed by one or more processors, the program code including instructions to:
identify, by each of the plurality of types of machine-learning models, historical keywords from historical communications between support agents and customers, in response to receiving the historical communications;
select historical keywords which were identified by at least a specific number of the plurality of types of machine-learning models;
identify some of the selected keywords from communications between support agents and customers, in response to receiving the communications; and
apply the identified keywords to at least one of recognizing skills required by a support agent to handle an open case, a trend in cases related to at least one of a product or a skill, or identifying skills for which support agents require additional training.

16. The computer program product of claim 15, wherein the historical communications are received based on at least one of a time range or a maximum number of most recent historical communications.

17. The computer program product of claim 15, wherein identifying historical keywords from historical communications between support agents and customers comprises determining for each individual historical keyword that a count of historical communications which include the individual historical keyword exceeds a threshold number of historical communications.

18. The computer program product of claim 15, wherein each machine-learning model identifies any number of historical keywords in each historical communication as a set of historical keywords for the historical communication.

19. The computer program product of claim 15, wherein each historical communication comprises at least one of an initial comment, an inbound comment from a customer to a support agent, an outbound comment from a support agent to a customer, an internal note on a case, made by a support agent for other support personnel, metadata, a textual communication, or an audio communication, and is associated with a communication length that is at least one of as long as a minimum length or as short as a maximum length.

20. The computer program product of claim 15, wherein the plurality of types of machine-learning models are based on at least one of a statistical model, an unsupervised machine-learning model, a supervised machine-learning model, or at least one large language model.
